(19) United States
(12) Patent Application Publication
(10) Pub. No.: US 2005/0195591 A1
(43) Pub. Date: Sep. 8, 2005

(54) LED writing instrument and glow-in-the-dark phosphorous writing surface

(76) Inventors: Raymond John Garcia, San Diego, CA (US); Brian Douglas Dick, San Diego, CA (US); Mark Stephen Brosamer, Berkeley, CA (US)

Correspondence Address: Mr. Mark Brosamer, 1328 Stannage Ave., Berkeley, CA, 94702, US

(21) Appl. No.: 10/793,436

(22) Filed: Mar. 4, 2004

(51) Int. Cl. B43K 29/10

(52) U.S. Cl. 362/118; 362/259; 362/253; 362/800

(57) ABSTRACT

The invention consists of a coupling of two items: a glow-in-the-ark writing surface and a writing/drawing instrument which emits light using a 350-480 nanometer Light Emitting Diode (LED) or Laser LED. The power source for the writing instrument is a portable direct current power source encased within the instrument. Light from the LED which strikes the writing surface causes it to glow. Moving the writing instrument creates a glowing effect wherever the light passes, allowing the user to draw patterns and/or images on the writing surface.

### CROSS REFERENCE TO RELATED APPLICATIONS

U.S. Pat. No. 6,614,179
U.S. Pat. No. 6,319,425
U.S. Pat. No. 5,540,786
U.S. Pat. No. 6,585,388

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention described herein addresses the problem of writing in low-light conditions and does so by coupling two previously existing technologies: luminescent material and low-frequency, 350-480 nanometer Light Emitting Diodes (LEDs) or Laser Diodes¹. When a focused beam of low- frequency light is passed over a surface covered or impregnated with luminescent material, the “trail” of the beam remains visible long enough for any image, word or mark to be recognized. The invention is primarily the improvement of low-light activities such as SCUBA diving (wherein divers in darkened conditions might use the invention to communicate), but can also be used for entertainment purposes, either as a drawing tool or game.
¹Hereafter, the use of the appellation “LED” will be used to signify both a 350480 nanometer Light Emitting Diode and Laser LED.

### BRIEF SUMMARY OF THE INVENTION

This invention is used to write in any darkened conditions (i.e. at night) for communication or entertainment purposes. It can be used to communicate through drawing in any low-light context (i.e. under water) or for artistic drawing/doodling or to play games (i.e. tic-tac-toe, or hangman). The invention is comprised of two principle components: the writing surface and the writing instrument.

The writing surface is impregnated with or covered by glow-in-the-dark material. On the side of the writing surface is attached a simple device (a hook, clip or strip of Velcro) to hold the writing instrument The writing instrument may take the general form of a traditional pen, but does not use ink. Instead, it encases a small Light Emitting Diode (LED) powered by a portable, direct current power source capable of activating the LED. When the LED is on, it will project light onto the writing surface. When the LED light source from the writing instrument passes across the writing surface, it leaves a glowing mark in its path which will remain visible for up to 90 seconds.

### BRIEF DESCRIPTION OF THE SEVERAL VIEWS OF THE DRAWING

FIG. 1: Writing/drawing surface

FIG. 2: writing instrument holder

FIG. 3: overview of invention's two components

FIG. 4: detail of writing instrument
LED
Limiting resistor
Power switch
Power source

FIG. 5: LED circuit
LED
Limiting resistor
Power switch
Power source

### DETAILED DESCRIPTION OF THE INVENTION

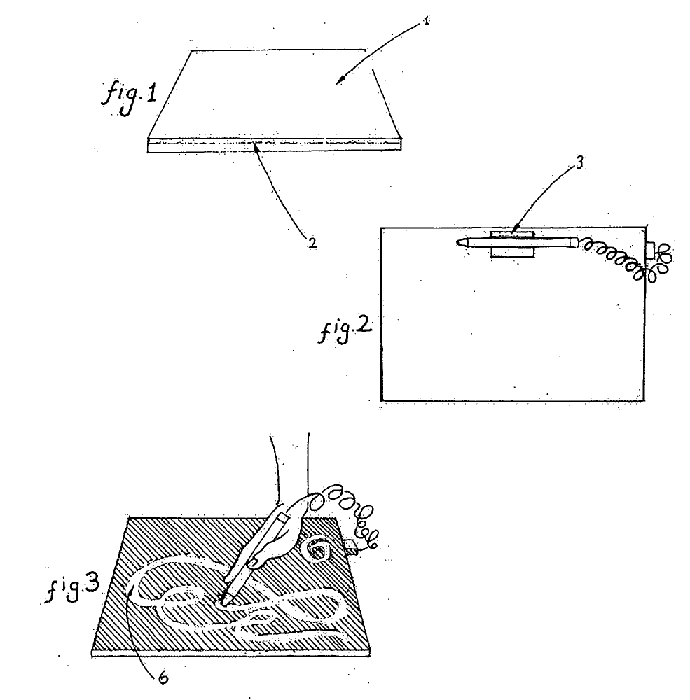

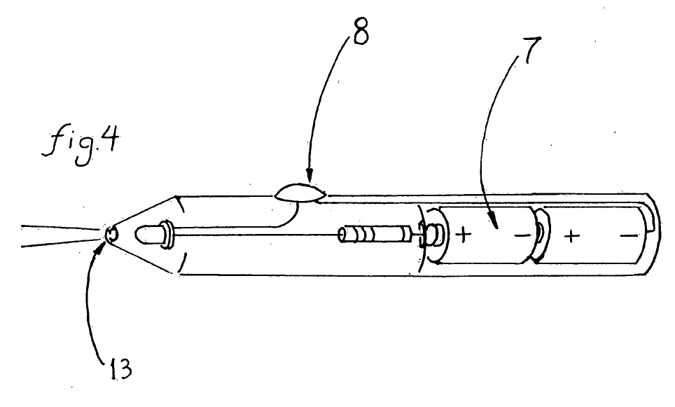

The writing surface (FIG. 1) is impregnated with or covered by glow-in-the dark material (FIG. 1.1) usually consisting of one of several possible luminescence activators: Zinc Sulfide with Copper, Strontium Aluminate with Europium (a non-radioactive phosphorescent pigment) or similar glowing material. On the side of the writing surface is attached a simple device (i.e. a clip or strip of Velcro) to hold the writing instrument when not in use (see FIG. 2.3).

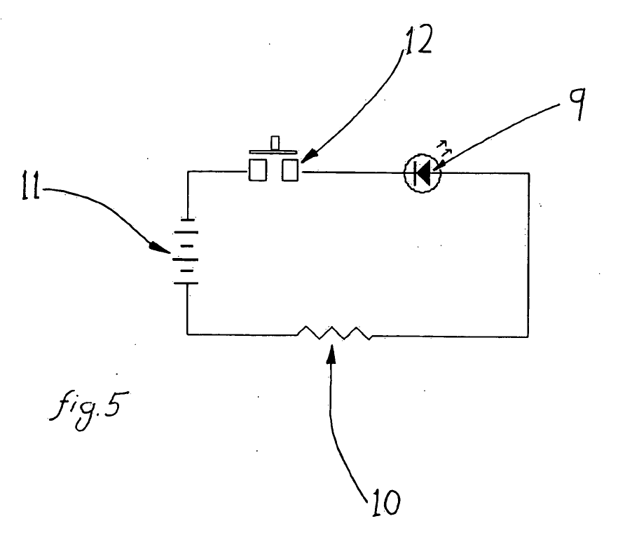

The writing instrument consists of a Light Emitting Diode (LED) for the light source (FIG. 4). A small orifice will allow a narrow stream of light to project onto the writing surface (see FIG. 4.13). Because of the frequency of the LED (350-480 manometers), when the stream of light from the writing instrument passes across the writing surface, it leaves a glowing mark in its path (FIG. 3.6). Any mark made onto the writing surface will remain visible for up to 90 seconds, depending on how close to the writing surface the LED is, the amount of luminescent material used in the making of the writing surface, and the intensity of other ambient light sources (i.e. sunlight, a lamp, etc.). The power source for activating the LED is a portable direct current power source (FIG. 4.7) attached to or enclosed within the chamber of the writing instrument. The writing instrument will house a switch (FIG. 4.8) to activate the LED.

The LED circuit (see FIG. 5) consists of an LED (FIG. 5.9), a current limiting resistor (FIG. 5.10) for the LED, a DC power source (FIG. 5.11) and a switch for activation (FIG. 5.12).

Variations on the invention include several attachments which can be temporarily affixed to the head of the writing instrument. These attachments can narrow or broaden or otherwise modify the focus of the light beam hitting the writing surface, creating thinner or thicker lines, respectively. Narrowing/focusing the beam of light will sharpen the “writing” and make for a more precise, narrower mark. Conversely, a wide beam will produce a thicker, less clearly defined mark. Another attachment consists of a “brush” made of fiber optic strands. When this attachment is affixed to the head of the writing instument and passed over the writing surface, the end of each strand leaves a glowing thin line on the writing surface, creating a “brushstroke” pattern.

Another variation on the product includes plastic stencils used to help draw on the writing surface. The stencils will be laid on the writing surface, and when the LED light source passes over them, the pattern traced around and though the stencil will remain as an after-image when the stencil is removed.

Prior inventions have attempted to address the problem of writing in low-light conditions. Most of these inventions have employed one of several techniques:
1. By using a “normal” (i.e. white) light source to illuminate a traditional method of writing (ink on paper, chalk on slate, grease pencil on plastic, etc.). In this case, inventors simply introduced a small “third party” light source as a means of seeing what has been written. One invention using this technique illuminates a traditional writing surface (i.e. paper) by implanting a Ught Emitting Diode (LED) in the body of a simple ball-point ink pen and projecting it downward along the ink column of the pen through the transparent tip of the pen's casing.
2. Illumination a translucent plastic surface from behind, hence silhouetting any mark made upon the plastic surface.

1. A hand-held writing or drawing instrument utilizing as its medium a Light Emitting Diode (LED) or Laser LED.

2. A hand-held writing or drawing instrument as cited in claim 1 wherein the LED or Laser LED light source must be between the wavelengths of 350-480 nanometers.

3. A hand-held writing instrument as cited in claim 1 whereas the instrument includes an attachable accessory designed to narrow or broaden the focus of the light beam.

4. A hand-held writing instrument as cited in claim 1 whereas the instrument includes an attachable brush made of fiber optic strands.

5. A hand-held writing instrument as cited in claim 1 whereas the instrument includes stencils used to trace images or patterns on the writing surface.

6. A writing surface either impregnated or covered with luminescent activators.

7. A writing surface as cited in claim 6 whereas the surface contains specific patterns designed to allow users to interact with the surface as a game (i.e. tic-tac-toe, “connect the dots”, etc.).

8. A writing surface as cited in claim 6 whereas the surface, by electronic or mechanical means, can be scrolled vertically or laterally to increase its surface area as the hand-held writing instrument (as cited in claim 1) is drawn across it.
